(19) United States
(12) Patent Application Publication
(10) Pub. No.: US 2017/0015876 A1
(43) Pub. Date: Jan. 19, 2017

(54) Propylene-Based Polymers for Use in Adhesive Compositions and Methods to Prepare Thereof

(71) Applicant: ExxonMobil Chemical Patents Inc., Baytown, TX (US)

(72) Inventors: Jurgen J.M. Schroeyers, Bierbeek (BE); James N. Coffey, League City, TX (US); Yann Devorest, Waterloo (BE); Jennifer J. Austin, The Woodlands, TX (US)

(21) Appl. No.: 15/165,505

(22) Filed: May 26, 2016

Related U.S. Application Data
(60) Provisional application No. 62/193,904, filed on Jul. 17, 2015.

(51) Int. Cl. C09J 123/12

(52) U.S. Cl. CPC C09J 123/12

(57) ABSTRACT

The present invention is related to an adhesive composition comprising (a) greater than about 65 wt % of a polymer blend and (b) a polar polyethylene components. The blend has a first and second propylene-based polymer, both different homopolymers of propylene or a copolymer of propylene and ethylene or a C₄ to C₁₀ alpha-olefin.

### CROSS REFERENCE TO RELATED APPLICATIONS

This invention claims priority to and the benefit of U.S. Ser. No. 62/193,904, filed Jul. 17, 2015.

### FIELD OF INVENTION

The invention relates to polyolefin adhesive compositions for use in packaging applications.

### BACKGROUND

Adhesive composition components such as base polymers, tackifiers, waxes, and oils are customarily provided as separate components for formulation into hot melt adhesive (HMA) compositions. In HMA packaging applications, adhesive compositions are sought that provide a desired combination of physical properties, including (a) low viscosity to enable easy processability of said formulations, (b) low set time, (c) suitable adhesive bond strength as measured by fiber tear, and (d) bond flexibility, over a broad application temperature range.

Exemplary base polymer compositions and methods of making polymer compositions for HMA applications that can be used for packaging applications are disclosed in U.S. Pat. Nos. 7,294,681 and 7,524,910. Various polymers described in these patents and/or produced by the methods disclosed in these patents have been sold by ExxonMobil Chemical Company as LINXAR™ polymers.

International Publication No. WO2013/134038 discloses a method for producing a polymer blend having at least two different propylene-based polymers produced in parallel reactors. The multi-modal polymer blend has a Mw of about 10,000 g/mol to about 150,000 g/mol. Adhesive formulations for packaging applications are prepared by combining a polymer, tackifier, and wax in equal quantities. Furthermore, it is generally known to add a functionalized polyolefin, such as a propylene-based maleic anhydride copolymer, to an adhesive composition, to impart good low temperature performance. However, use of such functionalized polyolefins may not be suitable for certain packaging articles used for food products. Accordingly, there remains a need for an adhesive formulation that has the new base polymer, that has minimal amounts of a functionalized polyolefin, without compromising adhesive properties at low temperatures.

### SUMMARY

In one aspect, the present invention relates to an adhesive composition comprising (a) a polymer blend comprising a first propylene-based polymer, wherein the first propylene-based polymer is a homopolymer of propylene or a copolymer of propylene and ethylene or a C₄ to C₁₀ alpha-olefin; a second propylene-based polymer, wherein the second propylene-based polymer is a homopolymer of propylene or a copolymer of propylene and ethylene or a C₄ to C₁₀ alpha-olefin; wherein the second propylene-based polymer is different than the first propylene-based polymer; wherein the polymer blend is present in the amount of about 65 wt % or more based on the adhesive composition; wherein the polymer blend has a melt viscosity, measured at 190° C. of about 900 to about 19,000 cP; and (b) a polar polyethylene component selected from at least one of an oxidized high density polyethylene wax, a silane-modified polyethylene, ethylene vinyl acetate, ethylene acrylate, organic acid-modified polyethylene, and combinations thereof.

### DETAILED DESCRIPTION

Various specific embodiments of the invention will now be described, including preferred embodiments and definitions that are adopted herein for purposes of understanding the claimed invention. While the illustrative embodiments have been described with particularity, it will be understood that various other modifications will be apparent to and can be readily made by those skilled in the art without departing from the spirit and scope of the invention. For determining infringement, the scope of the “invention” will refer to any one or more of the appended claims, including their equivalents and elements or limitations that are equivalent to those that are recited.

The inventors have discovered adhesive compositions utilizing one or more polar polyethylene components combined with a base polymer, serves as a suitable replacement (in whole or in part) for adhesive compositions with functionalized polyolefins, without compromising suitable adhesive properties including set time, fiber tear, failure mode, and bond flexibility.

The inventive adhesives may be produced using a new process platform that is more robust and lacks many of the limitations and difficulties associated with the processes employed to make LINXAR™ polymers and those disclosed in U.S. Pat. Nos. 7,294,681 and 7,524,910. Advantageously, about 50 wt % to about 95 wt % of one or more polymer blends is used in adhesive formulations when the polymer blend has a melt viscosity of about 1,000 cP to about 30,000 cP.

### A. Methods of Preparing Polymer Blends and Compositions

A solution polymerization process for preparing polymer blends is generally performed by a system that includes a first reactor, a second reactor in parallel with the first reactor, a liquid-phase separator, a devolatilizing vessel, and a pelletizer. The first reactor and second reactor may be, for example, continuous stirred-tank reactors.

The first reactor may receive a first monomer feed, a second monomer feed, and a catalyst feed. The first reactor may also receive feeds of a solvent and an activator. The solvent and/or the activator feed may be combined with any of the first monomer feed, the second monomer feed, or catalyst feed or the solvent and activator may be supplied to the reactor in separate feed streams. A first polymer is produced in the first reactor and is evacuated from the first reactor via a first product stream. The first product stream comprises the first polymer, solvent, and any unreacted monomer.

In any embodiment, the first monomer in the first monomer feed may be propylene and the second monomer in the second monomer feed may be ethylene or a C₄ to C₁₀ olefin. In any embodiment, the second monomer may be ethylene, butene, hexene, and octene. Generally, the choice of monomers and relative amounts of chosen monomers employed in the process depends on the desired properties of the first polymer and final polymer blend. For adhesive compositions, ethylene and hexene are particularly preferred comonomers for copolymerization with propylene. In any embodiment, the relative amounts of propylene and comonomer supplied to the first reactor may be designed to produce a polymer that is predominantly propylene, i.e., a polymer that is more than 50 mol % propylene. In another embodiment, the first reactor may produce a homopolymer of propylene.

The second polymer is different than the first polymer. The difference may be measured, for example, by the comonomer content, heat of fusion, crystallinity, branching index, weight average molecular weight, and/or polydispersity of the two polymers. In any embodiment, the second polymer may comprise a different comonomer than the first polymer or one polymer may be a homopolymer of propylene and the other polymer may comprise a copolymer of propylene and ethylene or a C₄ to C₁₀ olefin. For example, the first polymer may comprise a propylene-ethylene copolymer and the second polymer may comprise a propylene-hexene copolymer. In any embodiment, the second polymer may have a different weight average molecular weight (Mw) than the first polymer and/or a different melt viscosity than the first polymer. Furthermore, in any embodiment, the second polymer may have a different crystallinity and/or heat of fusion than the first polymer.

It should be appreciated that any number of additional reactors may be employed to produce other polymers that may be integrated with (e.g., grafted) or blended with the first and second polymers. Further description of exemplary methods for polymerizing the polymers described herein may be found in U.S. Pat. No. 6,881,800, which is incorporated by reference herein.

The first product stream and second product stream may be combined to produce a blend stream. For example, the first product stream and second product stream may supply the first and second polymer to a mixing vessel, such as a mixing tank with an agitator.

The blend stream may be fed to a liquid-phase separation vessel to produce a polymer rich phase and a polymer lean phase. The polymer lean phase may comprise the solvent and be substantially free of polymer. At least a portion of the polymer lean phase may be evacuated from the liquid-phase separation vessel via a solvent recirculation stream. The solvent recirculation stream may further include unreacted monomer. At least a portion of the polymer rich phase may be evacuated from the liquid-phase separation vessel via a polymer rich stream.

In any embodiment, the liquid-phase separation vessel may operate on the principle of Lower Critical Solution Temperature (LCST) phase separation. This technique uses the thermodynamic principle of spinodal decomposition to generate two liquid phases; one substantially free of polymer and the other containing the dissolved polymer at a higher concentration than the single liquid feed to the liquid-phase separation vessel.

Employing a liquid-phase separation vessel that utilizes spinodal decomposition to achieve the formation of two liquid phases may be an effective method for separating solvent from multi-modal polymer blends, particularly in cases in which one of the polymers of the blend has a weight average molecular weight less than 100,000 g/mol, and even more particularly between 10,000 g/mol and 60,000 g/mol. The concentration of polymer in the polymer lean phase may be further reduced by catalyst selection.

Upon exiting the liquid-phase separation vessel, the polymer rich stream may then be fed to a devolatilizing vessel for further polymer recovery. In any embodiment, the polymer rich stream may also be fed to a low pressure separator before being fed to the inlet of the devolatilizing vessel. While in the vessel, the polymer composition may be subjected to a vacuum in the vessel such that at least a portion of the solvent is removed from the polymer composition and the temperature of the polymer composition is reduced, thereby forming a second polymer composition comprising the multi-modal polymer blend and having a lower solvent content and a lower temperature than the polymer composition as the polymer composition is introduced into the vessel. The polymer composition may then be discharged from the outlet of the vessel via a discharge stream.

The cooled discharge stream may then be fed to a pelletizer where the multi-modal polymer blend is then discharged through a pelletization die as formed pellets. Pelletization of the polymer may be by an underwater, hot face, strand, water ring, or other similar pelletizer. Preferably an underwater pelletizer is used, but other equivalent pelletizing units known to those skilled in the art may also be used. General techniques for underwater pelletizing are known to those of ordinary skill in the art.

Exemplary methods for producing useful polymer blends are further described in International Publication No. WO2013/134038, which is incorporated herein in its entirety. In particular, the catalyst systems used for producing semi-crystalline polymers of the polymer blend may comprise a metallocene compound and activator such as those described in International Publication No. WO2013/134038. Exemplary catalysts may include dimethylsilyl bis(2-methyl-4-phenylindenyl) zirconium dichloride, dimethylsilyl bis(2-methyl-5-phenylindenyl) hafnium dichloride, dimethylsilyl bis(2-methyl-4-phenylindenyl) zirconium dimethyl, and dimethylsilyl bis(2-methyl-4-phenylindenyl) hafnium dimethyl.

### B. Polymers

As described herein, the polymer blend comprises a first propylene-based polymer and a second propylene-based polymer. Preferred first and/or second propylene-based polymers of the polymer blend are semi-crystalline propylene-based polymers. In any embodiment, the polymers may have a relatively low molecular weight, preferably about 150,000 g/mol or less. In any embodiment, the polymer may comprise a comonomer selected from the group consisting of ethylene and linear or branched C₄ to C₂₀ olefins and diolefins. In any embodiment, the comonomer may be ethylene or a C₄ to C₁₀ olefin.

The term “polymer” as used herein includes, but is not limited to, homopolymers, copolymers, interpolymers, terpolymers, etc. and alloys and blends thereof. Further, as used herein, the term “copolymer” is meant to include polymers having two or more monomers, optionally with other monomers, and may refer to interpolymers, terpolymers, etc. The term “polymer” as used herein also includes impact, block, graft, random and alternating copolymers. The term “polymer” shall further include all possible geometrical configurations unless otherwise specifically stated. Such configurations may include isotactic, syndiotactic and random symmetries. The term “polymer blend” as used herein includes, but is not limited to, a blend of one or more polymers prepared in solution or by physical blending, such as melt blending.

“Propylene-based” as used herein, is meant to include any polymer comprising propylene, either alone or in combination with one or more comonomers, in which propylene is the major component (i.e., greater than 50 mol % propylene).

In any embodiment, one or more polymers of the polymer blend may comprise one or more propylene-based polymers, which comprise propylene and from about 2 mol % to about 30 mol % of one or more comonomers selected from C₂ and C₄-C₁₀ α-olefins. In any embodiment, the α-olefin comonomer units may derive from ethylene, butene, pentene, hexene, 4-methyl-1-pentene, octene, or decene. The embodiments described below are discussed with reference to ethylene and hexene as the α-olefin comonomer, but the embodiments are equally applicable to other copolymers with other α-olefin comonomers. In this regard, the copolymers may simply be referred to as propylene-based polymers with reference to ethylene or hexene as the α-olefin.

In any embodiment, the one or more propylene-based polymers of the polymer blend may include at least about 5 mol %, at least about 6 mol %, at least about 7 mol %, or at least about 8 mol %, or at least about 10 mol %, or at least about 12 mol % ethylene-derived or hexene-derived units. In those or other embodiments, the copolymers of the propylene-based polymer may include up to about 30 mol %, or up to about 25 mol %, or up to about 22 mol %, or up to about 20 mol %, or up to about 19 mol %, or up to about 18 mol %, or up to about 17 mol % ethylene-derived or hexene-derived units, where the percentage by mole is based upon the total moles of the propylene-derived and α-olefin derived units. Stated another way, the propylene-based polymer may include at least about 70 mol %, or at least about 75 mol %, or at least about 80 mol %, or at least about 81 mol % propylene-derived units, or at least about 82 mol % propylene-derived units, or at least about 83 mol % propylene-derived units; and in these or other embodiments, the copolymers of the propylene-based polymer may include up to about 95 mol %, or up to about 94 mol %, or up to about 93 mol %, or up to about 92 mol %, or up to about 90 mol %, or up to about 88 mol % propylene-derived units, where the percentage by mole is based upon the total moles of the propylene-derived and alpha-olefin derived units. In any embodiment, the propylene-based polymer may comprise from about 5 mol % to about 25 mol % ethylene-derived or hexene-derived units, or from about 8 mol % to about 20 mol % ethylene-derived or hexene-derived units, or from about 12 mol % to about 18 mol % ethylene-derived or hexene-derived units.

The one or more polymers of the blend of one or more embodiments are characterized by a melting point (Tm), which can be determined by differential scanning calorimetry (DSC). For purposes herein, the maximum of the highest temperature peak is considered to be the melting point of the polymer. A “peak” in this context is defined as a change in the general slope of the DSC curve (heat flow versus temperature) from positive to negative, forming a maximum without a shift in the baseline where the DSC curve is plotted so that an endothermic reaction would be shown with a positive peak.

In any embodiment, the Tm of the one or more polymers of the blend (as determined by DSC) may be less than about 130° C., or less than about 125° C., or less than about 120° C., or less than about 115° C., or less than about 110° C., or less than about 100° C., or less than about 90° C., and greater than about 70° C., or greater than about 75° C., or greater than about 80° C., or greater than about 85° C. In any embodiment, the Tm of the one or more polymers of the blend may be greater than about 25° C., or greater than about 30° C., or greater than about 35° C., or greater than about 40° C.

Tm of the polymer blend can be determined by taking 5 to 10 mg of a sample of the polymer blend, equilibrating a DSC Standard Cell FC at −90° C., ramping the temperature at a rate of 10° C. per minute up to 200° C., maintaining the temperature for 5 minutes, lowering the temperature at a rate of 10° C. per minute to −90° C., ramping the temperature at a rate of 10° C. per minute up to 200° C., maintaining the temperature for 5 minutes, and recording the temperature as Tm.

In one or more embodiments, the crystallization temperature (Tc) of the polymer blend (as determined by DSC) is less than about 110° C., or less than about 90° C., or less than about 80° C., or less than about 70° C., or less than about 65° C. In the same or other embodiments, the Tc of the polymer is greater than about 25° C.

The polymers suitable for use herein are said to be “semi-crystalline”, meaning that in general they have a relatively low crystallinity. The term “crystalline” as used herein broadly characterizes those polymers that possess a high degree of both inter and intra molecular order, and which preferably melt higher than 110° C., more preferably higher than 115° C., and most preferably above 130° C. A polymer possessing a high inter and intra molecular order is said to have a “high” level of crystallinity, while a polymer possessing a low inter and intra molecular order is said to have a “low” level of crystallinity. Crystallinity of a polymer can be expressed quantitatively, e.g., in terms of percent crystallinity, usually with respect to some reference or benchmark crystallinity. As used herein, crystallinity is measured with respect to isotactic polypropylene homopolymer. Preferably, heat of fusion is used to determine crystallinity. Thus, for example, assuming the heat of fusion for a highly crystalline polypropylene homopolymer is 190 J/g, a semi-crystalline propylene copolymer having a heat of fusion of 95 J/g will have a crystallinity of 50%. The term “crystallizable” as used herein refers to those polymers which can crystallize upon stretching or annealing. Thus, in certain specific embodiments, the semi-crystalline polymer may be crystallizable. The semi-crystalline polymers used in specific embodiments of this invention preferably have a crystallinity of from 2% to 65% of the crystallinity of isotatic polypropylene. In further embodiments, the semi-crystalline polymers may have a crystallinity of from about 3% to about 40%, or from about 4% to about 30%, or from about 5% to about 25% of the crystallinity of isotactic polypropylene.

The semi-crystalline polymer of the polymer blend can have a level of isotacticity expressed as percentage of isotactic triads (three consecutive propylene units), as measured by ¹³C NMR, of 75 mol % or greater, 80 mol % or greater, 85 mol % or greater, 90 mol % or greater, 92 mol % or greater, 95 mol % or greater, or 97 mol % or greater. In one or more embodiments, the triad tacticity may range from about 75 mol % to about 99 mol %, or from about 80 mol % to about 99 mol %, or from about 85 mol % to about 99 mol %, or from about 90 mol % to about 99 mol %, or from about 90 mol % to about 97 mol %, or from about 80 mol % to about 97 mol %. Triad tacticity is determined by the methods described in U.S. Patent Application Publication No. 2004/0236042.

The semi-crystalline polymer of the polymer blend may have a tacticity index m/r ranging from a lower limit of 4, or 6 to an upper limit of 10, or 20, or 25. The tacticity index, expressed herein as “m/r”, is determined by ¹³C nuclear magnetic resonance (“NMR”). The tacticity index m/r is calculated as defined by H. N. Cheng in 17 Macromolecules, 1950 (1984), incorporated herein by reference. The designation “m” or “r” describes the stereochemistry of pairs of contiguous propylene groups, “m” referring to meso and “r” to racemic. An m/r ratio of 1.0 generally describes an atactic polymer, and as the m/r ratio approaches zero, the polymer is increasingly more syndiotactic. The polymer is increasingly isotactic as the m/r ratio increases above 1.0 and approaches infinity.

In one or more embodiments, the semi-crystalline polymer of the polymer blend may have a density of from about 0.85 g/cm³ to about 0.92 g/cm³, or from about 0.86 g/cm³ to about 0.90 g/cm³, or from about 0.86 g/cm³ to about 0.89 g/cm³ at room temperature and determined according to ASTM D-792. As used herein, the term “room temperature” is used to refer to the temperature range of about 20° C. to about 23.5° C.

In one or more embodiments, the semi-crystalline polymer can have a weight average molecular weight (Mw) of from about 5,000 to about 500,000 g/mol, or from about 7,500 to about 300,000 g/mol, or from about 10,000 to about 200,000 g/mol, or from about 25,000 to about 175,000 g/mol.

Weight-average molecular weight, M_{w}, molecular weight distribution (MWD) or M_{w}/Mₙ where Mₙ is the number-average molecular weight, and the branching index, g′(vis), are characterized using a High Temperature Size Exclusion Chromatograph (SEC), equipped with a differential refractive index detector (DRI), an online light scattering detector (LS), and a viscometer. Experimental details not shown below, including how the detectors are calibrated, are described in: T. Sun, P. Brant, R. R. Chance, and W. W. Graessley, Macromolecules, Volume 34, Number 19, pp. 6812-6820, 2001. In one or more embodiments, the polymer blend can have a polydispersity index of from about 1.5 to about 6.

Solvent for the SEC experiment is prepared by dissolving 6 g of butylated hydroxy toluene as an antioxidant in 4 L of Aldrich reagent grade 1,2,4 trichlorobenzene (TCB). The TCB mixture is then filtered through a 0.7 μm glass pre-filter and subsequently through a 0.1 μm Teflon filter. The TCB is then degassed with an online degasser before entering the SEC. Polymer solutions are prepared by placing the dry polymer in a glass container, adding the desired amount of TCB, then heating the mixture at 160° C. with continuous agitation for about 2 hr. All quantities are measured gravimetrically. The TCB densities used to express the polymer concentration in mass/volume units are 1.463 g/mL at room temperature and 1.324 g/mL at 135° C. The injection concentration ranges from 1.0 to 2.0 mg/mL, with lower concentrations being used for higher molecular weight samples. Prior to running each sample the DRI detector and the injector are purged. Flow rate in the apparatus is then increased to 0.5 mL/min, and the DRI was allowed to stabilize for 8-9 hr before injecting the first sample. The LS laser is turned on 1 to 1.5 hr before running samples. As used herein, the term “room temperature” is used to refer to the temperature range of about 20° C. to about 23.5° C.

The concentration, c, at each point in the chromatogram is calculated from the baseline-subtracted DRI signal, I_{DRI}, using the following equation:

c=K_{DRI}I_{DRI}/^{(dn/dc)}

where K_{DRI} is a constant determined by calibrating the DRI, and dn/dc is the same as described below for the LS analysis. Units on parameters throughout this description of the SEC method are such that concentration is expressed in g/cm³, molecular weight is expressed in kg/mol, and intrinsic viscosity is expressed in dL/g.

The light scattering detector used is a Wyatt Technology High Temperature mini-DAWN. The polymer molecular weight, M, at each point in the chromatogram is determined by analyzing the LS output using the Zimm model for static light scattering (M. B. Huglin, Light Scattering from Polymer Solutions, Academic Press, 1971):

[Kₒc/ΔR(θ,c)]=[1/MP(θ)]+2A₂c

where ΔR(θ) is the measured excess Rayleigh scattering intensity at scattering angle θ, c is the polymer concentration determined from the DRI analysis, A₂ is the second virial coefficient, P(θ) is the form factor for a monodisperse random coil (described in the above reference), and Kₒ is the optical constant for the system:

$${K}_{o} = \frac{4 {π}^{2} {{n}^{2} ( d n / d c )}^{2}}{{λ}^{4} {N}_{A}}$$

in which N_{A} is the Avogadro's number, and dn/dc is the refractive index increment for the system. The refractive index, n=1.500 for TCB at 135° C. and λ=690 nm. In addition, A₂=0.0015 and dn/dc=0.104 for ethylene polymers, whereas A₂=0.0006 and dn/dc=0.104 for propylene polymers.

The molecular weight averages are usually defined by considering the discontinuous nature of the distribution in which the macromolecules exist in discrete fractions i containing Nᵢ molecules of molecular weight Mᵢ. The weight-average molecular weight, M_{w}, is defined as the sum of the products of the molecular weight Mᵢ of each fraction multiplied by its weight fraction wᵢ:

M_{w}≡ΣwᵢMᵢ=(ΣNᵢMᵢ²/ΣNᵢMᵢ)

since the weight fraction wᵢ is defined as the weight of molecules of molecular weight Mᵢ divided by the total weight of all the molecules present:

wᵢ=NᵢMᵢ/ΣNᵢMᵢ

The number-average molecular weight, Mₙ, is defined as the sum of the products of the molecular weight Mᵢ of each fraction multiplied by its mole fraction xᵢ:

Mₙ≡ΣxᵢMᵢ=ΣNᵢMᵢ/ΣNᵢ

since the mole fraction xᵢ is defined as Nᵢ divided by the total number of molecules:

xᵢ=Nᵢ/ΣNᵢ

In the SEC, a high temperature Viscotek Corporation viscometer is used, which has four capillaries arranged in a Wheatstone bridge configuration with two pressure transducers. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])²

where c was determined from the DRI output.

The branching index (g′, also referred to as g′(vis)) is calculated using the output of the SEC-DRI-LS-VIS method as follows. The average intrinsic viscosity, [η]_{avg}, of the sample is calculated by:

$${[ η ]}_{avg} = \frac{\sum {{c}_{i} [ η ]}_{i}}{\sum {c}_{i}}$$

where the summations are over the chromatographic slices, i, between the integration limits.

The branching index g′ is defined as:

$${g}^{′} = \frac{{[ η ]}_{avg}}{{kM}_{v}^{α}}$$

where k=0.000579 and α=0.695 for ethylene polymers; k=0.0002288 and α=0.705 for propylene polymers; and k=0.00018 and α=0.7 for butene polymers.

Mᵥ is the viscosity-average molecular weight based on molecular weights determined by the LS analysis:

Mᵥ≡(ΣcᵢMᵢ^{α}/Σcᵢ)^{1/α.}

In one or more embodiments, the semi-crystalline polymer of the polymer blend may have a viscosity (also referred to a Brookfield viscosity or melt viscosity), measured at 190° C. and determined according to ASTM D-3236 from about 100 cP to about 500,000 cP, or from about 100 to about 100,000 cP, or from about 100 to about 50,000 cP, or from about 100 to about 25,000 cP, or from about 100 to about 15,000 cP, or from about 100 to about 10,000 cP, or from about 100 to about 5,000 cP, or from about 500 to about 15,000 cP, or from about 500 to about 10,000 cP, or from about 500 to about 5,000 cP, or from about 1,000 to about 10,000 cP, wherein 1 cP=1 mPa·sec.

The polymers that may be used in the adhesive compositions disclosed herein generally include any of the polymers according to the process disclosed in International Publication No. WO2013/134038. The triad tacticity and tacticity index of a polymer may be controlled by the catalyst, which influences the stereoregularity of propylene placement, the polymerization temperature, according to which stereoregularity can be reduced by increasing the temperature, and by the type and amount of a comonomer, which tends to reduce the length of crystalline propylene derived sequences.

### C. Polar Polyethylene Component

The adhesive composition of the present invention includes one or more polar polyethylene components. As used herein, the term “polar polyethylene component” includes an oxidized high density polyethylene wax, a silane-modified polyethylene, ethylene vinyl acetate, ethylene acrylate, and organic acid-modified polyethylene. As used herein, the term “ethylene acrylate” includes ethylene n-butyl acrylate, ethylene methyl acrylate, and ethylene acrylic acid. In a preferred embodiment, the polar polyethylene component is an oxidized high density polyethylene wax and/or an organic acid-modified polyethylene. Suitable commercially available polar polyethylene components include, but are not limited to, A-C 645P, A-C 580, A-C 395, A-C 325, A-C 330, commercially available from Honeywell, and Licocene 5301, commercially available from Clariant. Preferably the polar polyethylene component is present in the adhesive composition in the amount of about greater than about 1 wt % or 2 wt % or 2.5 wt % to less than about 3 wt % or 4 wt % or 5 wt %.

### D. Functionalized Polyolefin

The adhesive composition of the present invention may include a functionalized polyolefin. The term “functionalized polyolefin” is used herein to refer to maleic anhydride-modified polypropylene and maleic anhydride-modified polypropylene wax. A useful commercially available functionalized polyolefin is Honeywell AC™-596 and Licocene PP MA 6452, both are polypropylene-based maleic anhydride copolymers. Generally, the functionalized polymer is present in the adhesive composition in the amount of greater than about 2 wt % or 3.5 wt % to less than about 10 wt %. In an embodiment, the adhesive composition is substantially free of a functionalized polyolefin.

### E. Other Additives

The HMA composition can include other additives, e.g., tackifiers, waxes, oils antioxidants, and combinations thereof either alone or in combination with one or more polar polyethylene components and optionally a functionalized polyolefin disclosed herein.

The term “tackifier” is used herein to refer to an agent that allows the polymer blend of the composition to be more adhesive by improving wetting during the application. Tackifiers may be produced from petroleum-derived hydrocarbons and monomers of feedstock including tall oil and other polyterpene or resin sources. Tackifying agents are added to give tack to the adhesive and also to modify viscosity. Tack is required in most adhesive formulations to allow for proper joining of articles prior to the HMA solidifying. As used herein, the term “tackifier” includes one or more tackifiers. Useful commercially available tackifiers are those under the trade name Escorez™, available from ExxonMobil Chemical Co. located in Baytown, Texas. Preferably, the tackifier is present in the amount of about greater than about 3 wt % or 5 wt % or 7.5 wt % or 10 wt % to less than about 12 wt % or 15 wt % or 20 wt % or 25 wt % based on the adhesive composition.

In an embodiment of the present invention, the adhesive composition comprises one or more oils. The term “oil” is used herein to refer to a substance that improves the fluidity of a material, and may also be referred to as a “plasticizer” or “plasticator”. Useful commercial available plasticizers include Primol™ 352, Spectrasyn 65, and epoxidized soybean oil. The invention is not limited to Primol™ 352, Spectrasyn 65, and epoxidized soybean oil as oils for use in the adhesive composition. Primol™ 352 is a white oil available from ExxonMobil Chemical. Spectrasyn 65 is polyalphaolefins available from ExxonMobil

Chemical. Preferably the oil is present in the invention in the amount of greater than about 1 wt % or 2 wt % to less than about 5 wt % based on the adhesive composition. In an embodiment of the invention, the adhesive composition is substantially free of an oil.

The term “antioxidant” is used herein to refer to high molecular weight hindered phenols and multifunctional phenols. A useful commercially available antioxidant is Irganox™ 1010, a hindered phenolic antioxidant available from BASF SE Corporation located in Ludwigshafen, Germany. The invention is not limited to Irganox 1010 as the antioxidant. In embodiments, other antioxidants that may be used with the polymer blends of the invention, including, but are not limited to amines, hydroquinones, phenolics, phosphites, and thioester antioxidants. Preferably, the antioxidant is present in the amount of about 0.5 to about 1 wt % based on the adhesive composition.

The term “wax” is used herein to refer to a substance that adjusts the overall viscosity of the adhesive composition. The primary function of wax is to control the set time and cohesion of the adhesive system. Adhesive compositions of the present invention may comprise paraffin (petroleum) waxes and microcrystalline waxes. In embodiments, the adhesive compositions may have no wax. In embodiments, other waxes may be used with the polymer blends of the invention including, but not limited to, Castor Oil derivatives (HCO-waxes), ethylene co-terpolymers, Fisher-Tropsch waxes, microcrystalline, paraffin, polyolefin modified, and polyolefin. Useful commercially available waxes include, but are not limited to, Epolene N15 and Epolene C15, commercially available from Westlake Chemical, Sylvares, commercially available from Arizona Chemical, Polywax 3000, commercially available from Baker Hughes, Paraflint H1, commercially available from Sasol, Calumet wax, Sarawax, commercially available from Shell GTL, and PX105, commercially available from Baker Petrolite. Preferably, the wax is present in the amount of greater than about 2 wt % or 5 wt % to less than about 10 wt % or 12 wt % based on the adhesive composition. In an embodiment, the adhesive composition is substantially free of a wax.

### F. Applications of Polyolefin Adhesive Compositions

In an embodiment, a packaging adhesive may comprise the adhesive composition of the present invention. A package may also comprise the adhesive composition of the present invention, wherein the adhesive as disclosed herein is applied to at least a portion of one or more packaging elements including paper, paperboard, containerboard, tagboard, corrugated board, chipboard, Kraft, cardboard, fiberboard, plastic resin, metal, metal alloys, foil, film, plastic film, laminates, and sheeting.

In an embodiment, the present invention may include a package comprising the adhesive composition as described herein, wherein the adhesive is applied to at least a portion of one or more packaging elements including cartons, containers, crates, cases, corrugated cases, and trays.

A package may also comprise the adhesive composition of the present invention, wherein the adhesive is applied to at least a portion of one or more packaging elements used in packaging of cereal products, cracker products, beer packaging, frozen food products, paper bags, drinking cups, milk cartons, juice cartons, drinking cups, and containers for shipping produce.

In an embodiment, the adhesive composition adheres two substrates, wherein each substrate comprises at least one of paper, cardboard, plastic, nonwoven, metal, wood, other natural fiber based material, or combinations thereof.

It should be appreciated that the adhesive formulations of the present disclosure, while being well suited for use in packaging products, may also find utility in other applications as well.

### EXAMPLES

“Set time” is the minimum time interval, after bonding two substrates, during which the cohesive strength of the bond becomes stronger than joint stress. It represents the time necessary to cool down an adhesive composition and obtain a good bond. Set time is determined by bonding together substrates with the adhesive after the molten adhesive (180° C.) has been dropped onto one of the substrates with an eye dropper. The second substrate is placed on top of the adhesive, and a 500 g weight is placed on top of the second substrate for even application. After a predetermined interval of time, the second substrate is removed and checked for fiber tear. If no fiber tear is found, a longer interval of time is tried. This is continued until fiber tear is found. This length of time is reported as the set time in seconds.

“Shear Adhesion Failure Temperature” or “SAFT” is defined as the temperature at which the adhesive bond of the composition fails when the bond is subjected to a stepwise temperature increase under a constant force that pulls the bond in the shear mode. In the present invention, SAFT was measured by the following method. A 12 g sample of HMA was placed in a square mold (15 cm×15 cm) 200-micron thick and put between two silicon papers in a press operated at 160° C. The press can be operated by the following procedure: a 7 minute preheating step, a 7 minute degassing step, a 30 second pressurizing step at 100 kN, and a cooling step using plates operated at room temperature for 30 seconds at 100 kN pressure. As used herein, the term “Room Temperature” is used to refer to the temperature range of about 20° C. to about 23.5° C. A 2 cm×2 cm area of HMA cut from the HMA preparation plate was placed on a 2.5 cm×8 cm wood sample in an oven for 5 minutes at 190° C. A 2.2 cm×7 cm strip of wood laminate substrate was placed on top of the molten HMA. To ensure a good adhesion, a 2 kg weight was placed on the bonded area for 1 minute. After a conditioning for 24 hours at 23° C. and 50% Relative Humidity, the test specimens were suspended vertically in an oven at 50° C. with a 1 kg load attached to the bottom and were held for 1 hour. The temperature of the oven was increased by 10° C. during 5-minute intervals, after which the specimen was held for 55 minutes at this temperature. The temperature was gradually increased until the bond failed, at which point the temperature and time were recorded. Generally, the SAFT of the HMA of the present invention ranges from about 70° C. to about 120° C.

“Tensile Strength” describes the maximum force required to pull apart an adhesive where it breaks. Tensile strength is measured in MPa.

“Mandrel Flexibility” describes the flexibility of adhesive formulations. Mandrel Flexibility was measured according to ASTM D3111. Mandrel Flexibility of the adhesives of the invention were evaluated at two temperatures (−18° C. and room temperature) and with three rods of different diameters (12.8 mm, 6.4 mm, and 3.2 mm). The flexibility reported in the examples of the invention is the rod diameter and temperature at which the formulation breaks, i.e., is not flexible. It is generally appreciated that where a formulation is not flexible at a certain temperature, any increase in temperature would result in improved flexibility.

“Fiber tear” describes the bond strength of the adhesive to the substrate and is measured at room temperature, 2° C. (refrigerator temperature), and −18° C. (freezer temperature). Fiber tear is a visual measurement as to the amount of paper substrate fibers that are attached to a bond after the substrates are torn apart. 100% fiber tear means the adhesive is stronger than the substrate and 100% of the adhesive is covered in substrate fibers. Fiber tear is determined by bonding together substrates with the adhesive. A drop of molten adhesive (180° C.) is positioned on one of the substrates. The second substrate is placed on top of the adhesive, and a 500 g weight is placed on top of the second substrate for even application. The adhesive is cooled at the referenced temperature for at least one hour. The substrates are then torn apart and the adhesive is inspected for fiber tear. In the present invention, fiber tear of at least 60% is desired. “Failure Mode” is used to describe the location of the adhesive once a peel or delamination test is performed. Adhesive failure (AF) is defined as 100% of the adhesive remaining to the original substrate. Adhesive transfer (AT) is defined as 100% of the adhesive transferring to the opposite substrate. Cohesive failure (CF) is defined as an adhesive split where there is adhesive on both substrates. As used herein, the term “Room Temperature” is used to refer to the temperature range of about 20° C. to about 23.5° C.

To apply the adhesive to the substrate, one or more polymer blends, optionally with other additives is preheated at the application temperature until the polymer is molten. The molten material is poured into a hot melt tank and allowed to equilibrate. The pump speed is set and the add-on is calculated based on the amount of adhesive that passes through the nozzle in a given time.

In a pilot plant, propylene-ethylene copolymers are produced by reacting a feed stream of propylene with a feed stream of ethylene in the presence of a metallocene catalyst. The adhesive blends presented in the Tables below are prepared by preheating the blend of one or additives to 177° C. The polymer blend is slowly added in a heated mantle at 177° C. to the molten liquid of additives until all of the polymer has been added and is completely blended. The components are blended by manual stirring using a spatula until all polymer pellets are melted and the mixture is homogeneous. The components are stirred for an additional 10 minutes. The adhesive blend is removed from the heating mantle, and poured onto release paper. After the adhesive blend solidifies, it is cut into small pieces for testing.

The polymer blend used in the example of the invention, Polymer Blend A, was produced in accordance with the method disclosed in International Publication No. WO2013/134038. The invention is not limited to the use of Polymer Blend A. Polymer Blend A has a viscosity at 190° C. of about 1200 cP, a shore hardness C of about 51, and an ethylene content of about 6 wt %. The comparative examples (referred to herein as Comparative or Control) are commercially available premium grades of hot melt adhesives for use by H.B. Fuller: Advantra 9250 and 9256.

Table 1 shows the effect of the polar polyethylene component and the functionalized polyolefin on the properties of the adhesive formulation. Specifically, Table 1 shows formulations 1A-5A and 8A having Polymer Blend A, a functionalized polyolefin (A-C 596), and a polar polyethylene component (A-C 395); formulations 6A and 7A have no functionalized polyolefin; and comparative formulations 9A-11A have no polar polyethylene component. All formulations were tested for SAFT, tensile strength, and flexibility. The results reported in Table 1 indicate that formulations with both a functionalized polyolefin and polar polyethylene component (1A-5A and 8A) had improved low temperature flexibility without compromising other properties, as compared to formulations with no polar polyethylene component (9A-11A).

Table 2 shows 65 adhesive formulations having various amounts and types of Polymer Blend A, tackifier, antioxidant, and optionally one or more polar polyethylene components. None of the formulations of Table 2 included a functionalized olefin. All formulations were evaluated for set time, fiber tear, failure mode, and appearance.

Table 3 shows eight adhesive formulations, 1C-4C and 8C include both a functionalized polyolefin and a polar polyethylene component and 5C-7C includes only a functionalized polyolefin. Overall, all formulations had suitable set time and fiber tear values. Formulation 8C has a significantly higher viscosity as compared to formulations 1C-7C, indicating that the addition of wax and/or oil can lower the viscosity of the resulting formulation.

Table 4 shows four adhesive formulations with varying types of polar polyethylene components. The properties of the formulations indicate that the polar polyethylene component can be selected to achieve a certain formulation viscosity or set time.

Table 5 shows twenty-one adhesive formulations. 1E, having only functionalized polyolefin (A-C 596) and no polar polyethylene component had an unfavorably high set time. Formulations 2E-8E and 10E-21E, having only a polar polyethylene component and no functionalized polyolefin displayed favorably low set time values. Formulation 9E, having both a polar polyethylene component and a functionalized polyolefin displayed favorable adhesive properties.

Certain embodiments and features have been described using a set of numerical upper limits and a set of numerical lower limits. It should be appreciated that ranges from any lower limit to any upper limit are contemplated unless otherwise indicated. Certain lower limits, upper limits, and ranges appear in one or more claims below. All numerical values are “about” or “approximately” the indicated value, and take into account experimental error and variations that would be expected by a person having ordinary skill in the art.

To the extent a term used in a claim is not defined above, it should be given the broadest definition which persons in the pertinent art have given, as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

TABLE 1

| | | Viscosity | | Tensile | | |
|---|---|---|---|---|---|---|
| Adhesive Formulation | | at 140° C. | SAFT | Strength | Set Time | |
| (wt % Adhesive) | | cP | ° C. | (MPa) | (sec) | Mandrel Flexibility |
| 1A | 90 wt % Polymer Blend A/ | 4385 | 82 | 5.3 | 0.8 | 12.8 mm, −18° C. |
| | 3.5 wt % A-C 596/ | | | | | |
| | 2.5 wt % A-C 395/ | | | | | |
| | 3.5 wt % Escorez 5400/ | | | | | |
| | 0.5 wt % Irganox 1010 | | | | | |
| 2A | 90 wt % Polymer Blend A/ | 4425 | 80 | 5.1 | 1.0 | 6.4 mm, −18° C. |
| | 3.5 wt % A-C 596/ | | | | | |
| | 2.5 wt % A-C 330/ | | | | | |
| | 3.5 wt % Escorez 5400/ | | | | | |
| | 0.5 wt % Irganox 1010 | | | | | |
| 3A | 79.5 wt % Polymer Blend A/ | 3421 | 81 | 4.2 | 3.0 | 12.8 mm, −18° C. |
| | 2 wt % A-C 596/ | | | | | |
| | 2 wt % A-C 395/ | | | | | |
| | 8 wt % Escorez 5380/ | | | | | |
| | 8 wt % Escorez 5690 | | | | | |
| | 0.5 wt % Irganox 1010 | | | | | |
| 4A | 79.5 wt % Polymer Blend A/ | 3446 | 77 | 4.1 | 3.0 | 12.8 mm, −18° C. |
| | 2 wt % A-C 596/ | | | | | |
| | 2 wt % A-C 330/ | | | | | |
| | 8 wt % Escorez 5380/ | | | | | |
| | 8 wt % Escorez 5690 | | | | | |
| | 0.5 wt % Irganox 1010 | | | | | |
| 5A | 75 wt % Polymer Blend A/ | 3404 | 77 | 3.9 | 1.0 | 12.8 mm, −18° C. |
| | 2 wt % A-C 596/ | | | | | |
| | 3 wt % A-C 330/ | | | | | |
| | 12 wt % Escorez 5400/ | | | | | |
| | 7.5 wt % Escorez 5690/ | | | | | |
| | 0.5 wt % Irganox 1010 | | | | | |
| 6A | 75 wt % Polymer Blend A/ | 3429 | 71 | 3.6 | 1.0 | 12.8 mm, −18° C. |
| | 3 wt % A-C 330/ | | | | | 12.8 mm, −18° C. |
| | 14 wt % Escorez 5400/ | | | | | |
| | 7.5 wt % Escorez 5690/ | | | | | |
| | 0.1 wt % HPN 20e/ | | | | | |
| | 0.5 wt % Irganox 1010 | | | | | |
| 7A | 75 wt % Polymer Blend A/ | 3171 | 71 | — | 1.0 | 12.8 mm, −18° C. |
| | 3 wt % A-C 330/ | | | | | 12.8 mm, −18° C. |
| | 2 wt % Sasolwax H1/ | | | | | |
| | 12 wt % Escorez 5400/ | | | | | |
| | 7.5 wt % Escorez 5690/ | | | | | |
| | 0.5 wt % Irganox 1010 | | | | | |
| 8A | 80 wt % Polymer Blend A/ | 3450 | 72 | — | 1.0 | 12.8 mm, −18° C. |
| | 2 wt % A-C 330/ | | | | | 12.8 mm, −18° C. |
| | 2 wt % Licocene PP MA 6452/ | | | | | |
| | 8 wt % Escorez 5380/ | | | | | |
| | 8 wt % Escorez 5690/ | | | | | |
| | 0.5 wt % Irganox 1010 | | | | | |
| COMPARATIVE EXAMPLES | | | | | | |
| 9A | 91 wt % Polymer Blend A/ | 3880 | 77 | 3.6 | 5 | 12.8 mm, |
| | 3.5 wt % A-C 596/ | | | | | Room Temperature |
| | 5 wt % Polywax 3000/ | | | | | 12.8 mm, |
| | 0.5 wt % Irganox 1010 | | | | | Room Temperature |
| 10A | 86.5 wt % Polymer Blend A/ | 3800 | 88 | — | 0.8 | 6.44 mm, |
| | 3 wt % A-C 596/ | | | | | Room Temperature |
| | 3 wt % Polywax 3000/ | | | | | 6.44 mm, |
| | 5 wt % Epolene C15/ | | | | | Room Temperature |
| | 2 wt % Sylvares 2040/ | | | | | |
| | 0.5 wt % Irganox 1010 | | | | | |
| 11A | 77 wt % Polymer Blend A/ | 2829 | 73 | 4.7 | 0.5 | 12.88 mm, Room |
| | 7.5 wt % Polywax 3000/ | | | | | Temperature |
| | 15 wt % Escorez 5600/ | | | | | 3.2 mm, Room Temperature |
| | 0.5 wt % Irganox 1010 | | | | | |

TABLE 2

| | | | | | % Fiber | % Fiber | % Fiber | |
|---|---|---|---|---|---|---|---|---|
| | | | Formulation | | Tear/ | Tear/ | Tear/ | |
| | | Set | Viscosity | | Failure | Failure | Failure | |
| | Adhesive Formulation | Time | (cP) | Brittle | Mode - | Mode - | Mode | Formulation |
| | (wt % of the Adhesive) | (sec) | at 177° C. | Test | −18° C. | 2° C. | 25° C. | Appearance |
| 1B | 80.5 wt % Polymer Blend A/ | 3.7-4 | 1,263 | Brittle | 0/ | 59/ | 100/ | White, Hazy |
| | 2 wt % Licocene 5301/ | | | | AB | FT; AB | FT | |
| | 17 wt % Escorez 5615/ | | | | | | | |
| | 0.5 wt % Irganox 1010 | | | | | | | |
| 2B | 80.5 wt % Polymer Blend A/ | 5.5 | 1,237 | Brittle | 0/ | 96/ | 100/ | Yellow, |
| | 2 wt % Polywax 3000/ | | | | AB | FT | FT | Hazy |
| | 17 wt % Escorez 5615/ | | | | | | | |
| | 0.5 wt % Irganox 1010 | | | | | | | |
| 3B | 80.5 wt % Polymer Blend A/ | 7.5-8 | 1,313 | Flex | 46/ | 94/ | 100/ | Slightly |
| | 2 wt % A-C 580/ | | | | AB; FT | FT | FT | Yellow, |
| | 17 wt % Escorez 5615/ | | | | | | | Hazy |
| | 0.5 wt % Irganox 1010 | | | | | | | |
| 4B | 80.5 wt % Polymer Blend A/ | 8.5-9 | 1,275 | Flex | 4/ | 92/ | 97/ | Slightly |
| | 2 wt % A-C 645P/ | | | | AB | FT | FT | Yellow, |
| | 17 wt % Escorez 5615/ | | | | | | | Hazy |
| | 0.5 wt % Irganox 1010 | | | | | | | |
| 5B | 80.5 wt % Polymer Blend A/ | 2.7 | 1,385 | Flex | 41/ | 98/ | 100/ | Yellow- |
| | 2 wt % A-C 395/ | | | | AB; FT | FT | FT | Brown, |
| | 17 wt % Escorez 5615/ | | | | | | | Hazy |
| | 0.5 wt % Irganox 1010 | | | | | | | |
| 6B | 80.5 wt % Polymer Blend A/ | 5.5-6 | 1,210 | Brittle | 0/ | 36/ | 100/ | Yellow, |
| | 2 wt % PX105/ | | | | AB | AB; FT | FT | Hazy |
| | 17 wt % Escorez 5615/ | | | | | | | |
| | 0.5 wt % Irganox 1010 | | | | | | | |
| 7B | 80.5 wt % Polymer Blend A/ | 2-2.3 | 1,270 | Brittle | 12/ | 76/ | 93/ | Yellow, |
| | 4 wt % Licocene 5301/ | | | | AB; FT | FT | FT | Clear |
| | 2 wt % Epolene N15/ | | | | | | | |
| | 13 wt % Escorez 5615/ | | | | | | | |
| | 0.5 wt % Irganox 1010 | | | | | | | |
| 8B | 80.5 wt % Polymer Blend A/ | 2.7-3 | 1,300 | Brittle | 47/ | 73/ | 93/ | Yellow, |
| | 2 wt % Licocene 5301/ | | | | FT | FT | FT | Clear |
| | 4 wt % Epolene N15/ | | | | | | | |
| | 13 wt % Escorez 5615/ | | | | | | | |
| | 0.5 wt % Irganox 1010 | | | | | | | |
| Control | Advantra 9256 | 1.5 | — | — | 20/ | 25/ | 89/ | Clear |
| | | | | | AB | AB | FT | |
| 9B | 70.5 wt % Polymer Blend A/ | 2.7-3 | 1,170 | Brittle | 0/ | 60/ | 98/ | White, |
| | 2 wt % Licocene 5301/ | | | | AB | FT | FT | Hazy |
| | 10 wt % Epolene N15/ | | | | | | | |
| | 17 wt % Escorez 5615 | | | | | | | |
| | 0.5 wt % Irganox 1010 | | | | | | | |
| 10B | 70.5 wt % Polymer Blend A/ | 2-2.3 | 1,315 | Flex | 4/ | 86/ | 96/ | Slightly |
| | 10 wt % A-C 330/ | | | | AB | FT | FT | Brown, |
| | 2 wt % Polywax 3000/ | | | | | | | Hazy |
| | 17 wt % Escorez 5615/ | | | | | | | |
| | 0.5 wt % Irganox 1010 | | | | | | | |
| 11B | 70.5 wt % Polymer Blend A/ | 5.5-5.7 | 1,195 | Flex | 0/ | 77/ | 91/ | Yellow, |
| | 2 wt % A-C 580/ | | | | AB | AB; FT | FT | Hazy |
| | 10 wt % Epolene N15/ | | | | | | | |
| | 17 wt % Escorez 5615/ | | | | | | | |
| | 0.5 wt % Irganox 1010 | | | | | | | |
| 12B | 70.5 wt % Polymer Blend A/ | 3-3.3 | 1,405 | Flex | 22/ | 84/ | 100/ | Yellow- |
| | 10 wt % A-C 330/ | | | | FT; AB | FT | FT | Brown, |
| | 2 wt % A-C 645P/ | | | | | | | Hazy |
| | 17 wt % Escorez 5615/ | | | | | | | |
| | 0.5 wt % Irganox 1010 | | | | | | | |
| 13B | 70.5 wt % Polymer Blend A/ | 1.5-2 | 1,260 | Flex | 0/ | 92/ | 98/ | — |
| | 2 wt % A-C 395/ | | | | AB | FT | FT | |
| | 10 wt % Epolene N15/ | | | | | | | |
| | 17 wt % Escorez 5615/ | | | | | | | |
| | 0.5 wt % Irganox 1010 | | | | | | | |
| 14B | 70.5 wt % Polymer Blend A/ | 5.5-6 | 1,125 | Brittle | 0/ | 40/ | 100/ | Slightly |
| | 10 wt % Epolene N15/ | | | | AB | FT | FT | Yellow, |
| | 2 wt % PX105/ | | | | | | | Hazy |
| | 17 wt % Escorez 5615/ | | | | | | | |
| | 0.5 wt % Irganox 1010 | | | | | | | |
| 15B | 70.5 wt % Polymer Blend A/ | 1.5 | 1,308 | Brittle | 33/ | 62/ | 98/ | — |
| | 4 wt % Licocene 5301/ | | | | AB; FT | FT | FT | |
| | 10 wt % A-C 330/ | | | | | | | |
| | 2 wt % Epolene N15/ | | | | | | | |
| | 13 wt % Escorez 5615/ | | | | | | | |
| | 0.5 wt % Irganox 1010 | | | | | | | |
| 16B | 70.5 wt % Polymer Blend A/ | 1.7 | 1,378 | Brittle | 39/ | 43/ | 90/ | White, |
| | 2 wt % Licocene 5301/ | | | | AB; FT | FT | FT | Slightly |
| | 10 wt % A-C 330/ | | | | | | | Hazy |
| | 4 wt % Epolene N15/ | | | | | | | |
| | 13 wt % Escorez 5615/ | | | | | | | |
| | 0.5 wt % Irganox 1010 | | | | | | | |
| Control | Advantra 9250 | 1.5 | — | — | 23/ | 67/ | 95/ | Yellow- |
| | | | | | AB | FT | FT | Brown, |
| | | | | | | | | Hazy |
| 17B | 80.5 wt % Polymer Blend A/ | 7.5 | 1,235 | Flex | 35/ | 94/ | 100/ | Yellow, |
| | 2 wt % A-C 580/ | | | | FT; AB | FT | FT | Hazy |
| | 8.5 wt % Escorez 5600/ | | | | | | | |
| | 8.5 wt % Escorez 5690/ | | | | | | | |
| | 0.5 wt % Irganox 1010 | | | | | | | |
| 18B | 80.5 wt % Polymer Blend A/ | 8-8.5 | 1,180 | Flex | 0/ | 80/ | 100/ | Yellow, |
| | 2 wt % A-C 645P/ | | | | AF | FT | FT | Hazy |
| | 8.5 wt % Escorez 5600/ | | | | | | | |
| | 8.5 wt % Escorez 5690/ | | | | | | | |
| | 0.5 wt % Irganox 1010 | | | | | | | |
| 19B | 80.5 wt % Polymer Blend A/ | 3-3.5 | 1,200 | Flex | 30/ | 98/ | 100/ | Yellow- |
| | 2 wt % A-C 395/ | | | | AB; FT | FT; SF | FT | Brown, |
| | 8.5 wt % Escorez 5600/ | | | | | | | Hazy |
| | 8.5 wt % Escorez 5690/ | | | | | | | |
| | 0.5 wt % Irganox 1010 | | | | | | | |
| 20B | 80.5 wt % Polymer Blend A/ | 5 | 1,285 | Flex | 48/ | 98/ | 100/ | Yellow, |
| | 4 wt % A-C 580/ | | | | FT; AB | FT | FT | Hazy |
| | 15 wt % Escorez 5615/ | | | | | | | |
| | 0.5 wt % Irganox 1010 | | | | | | | |
| 21B | 80.5 wt % Polymer Blend A/ | 7-7.5 | 1,285 | Flex | 10/ | 73/ | 100/ | Yellow, |
| | 4 wt % A-C 645P/ | | | | AB | FT; AB | FT | Hazy |
| | 15 wt % Escorez 5615/ | | | | | | | |
| | 0.5 wt % Irganox 1010 | | | | | | | |
| 22B | 80.5 wt % Polymer Blend A/ | 2.7-3 | 1,350 | Flex | 8/ | 54/ | 100/ | Yellow- |
| | 4 wt % A-C 395/ | | | | AB | AB; FT | FT | Brown, |
| | 15 wt % Escorez 5615/ | | | | | | | Hazy |
| | 0.5 wt % Irganox 1010 | | | | | | | |
| 23B | 79.5 wt % Polymer Blend A/ | 2-2.3 | 1,100 | Brittle | 0/ | 46/ | 100/ | White- |
| | 5 wt % Polywax 3000/ | | | | AB | AB; FT | FT | Yellow, |
| | 7.5 wt % Escorez 5600/ | | | | | | | Hazy |
| | 7.5 wt % Escorez 5690/ | | | | | | | |
| | 0.5 wt % Irganox 1010 | | | | | | | |
| 24B | 70.5 wt % Polymer Blend A/ | 1.5-1.7 | 1,300 | Brittle | 0/ | 69/ | 96/ | Yellow- |
| | 10 wt % A-C 330/ | | | | AB | FT | FT | Brown, Hazy |
| | 4 wt % Polywax 3000/ | | | | | | | |
| | 15 wt % Escorez 5615/ | | | | | | | |
| | 0.5 wt % Irganox 1010 | | | | | | | |
| 25B | 70.5 wt % Polymer Blend A/ | 4-4.5 | 1,260 | Flex | 10/ | 64/ | 87/ | Slightly |
| | 4 wt % A-C 580/ | | | | AB | AB; FT | FT | Yellow, |
| | 10 wt % Epolene N15/ | | | | | | | Hazy |
| | 15 wt % Escorez 5615/ | | | | | | | |
| | 0.5 wt % Irganox 1010 | | | | | | | |
| 26B | 70.5 wt % Polymer Blend A/ | 2.7 | 1,440 | Flex | 35/ | 67/ | 92/ | Yellow- |
| | 10 wt % A-C 330/ | | | | AB; FT | FT; AB | FT | Brown, |
| | 4 wt % A-C 645P/ | | | | | | | Hazy |
| | 15 wt % Escorez 5615/ | | | | | | | |
| | 0.5 wt % Irganox 1010 | | | | | | | |
| 27B | 70.5 wt % Polymer Blend A/ | 1.5 | 1,260 | Brittle | 22/ | 90/ | 99/ | Yellow- |
| | 4 wt % A-C 395/ | | | | AB | FT | FT | Brown, Hazy |
| | 10 wt % Epolene N15/ | | | | | | | |
| | 0.5 wt % Irganox 1010 | | | | | | | |
| 28B | 65.5 wt % Polymer Blend A/ | 1.3-1.5 | 1,360 | Brittle | 6/ | 47/ | 90/ | Yellow- |
| | 15 wt % A-C 330/ | | | | AB | FT; AB | FT | Brown, |
| | 4 wt % Polywax 3000/ | | | | | | | Hazy |
| | 0.5 wt % Irganox 1010 | | | | | | | |
| 29B | 65.5 wt % Polymer Blend A/ | 3 | 1,240 | Flex | 0/ | 26/ | 76/ | Slightly |
| | 4 wt % A-C 580/ | | | | AB | FT; AB | FT | Yellow, |
| | 15 wt % Epolene N15/ | | | | | | | Hazy |
| | 15 wt % Escorez 5615/ | | | | | | | |
| | 0.5 wt % Irganox 1010 | | | | | | | |
| 30B | 65.5 wt % Polymer Blend A/ | 2.3-2.5 | 1,560 | Flex | 0/ | 62/ | 87/ | Yellow- |
| | 15 wt % A-C 330/ | | | | AB | FT | FT | Brown, |
| | 4 wt % A-C 645P/ | | | | | | | Hazy |
| | 15 wt % Escorez 5615/ | | | | | | | |
| | 0.5 wt % Irganox 1010 | | | | | | | |
| 31B | 65.5 wt % Polymer Blend A/ | 1.3-1.5 | 1,245 | Brittle | 45/ | 70/ | 98/ | Yellow- |
| | 4 wt % A-C 395/ | | | | FT; AB | FT | FT | Brown, |
| | 15 wt % Epolene N15/ | | | | | | | Hazy |
| | 15 wt % Escorez 5615/ | | | | | | | |
| | 0.5 wt % Irganox 1010 | | | | | | | |
| 32B | 70.5 wt % Polymer Blend A/ | 1.7-2 | 1,232 | Flex | 4/ | 86/ | 94/ | Yellow, |
| | 2 wt % A-C 395/ | | | | AB; FT | FT | FT | Hazy |
| | 10 wt % Epolene N15/ | | | | | | | |
| | 17 wt % Escorez 5615/ | | | | | | | |
| | 0.5 wt % Irganox 1010 | | | | | | | |
| 33B | 70.5 wt % Polymer Blend A/ | 1.7-2 | 1,155 | Flex | 2/ | 83/ | 85/ | Yellow, |
| | 2 wt % A-C 395/ | | | | AB | FT | FT | Hazy |
| | 10 wt % Epolene N15/ | | | | | | | |
| | 17 wt % Escorez 5600/ | | | | | | | |
| | 0.5 wt % Irganox 1010 | | | | | | | |
| 34B | 70.5 wt % Polymer Blend A/ | 1.5 | 1,122 | Flex | 10/ | 90/ | 97/ | Yellow, |
| | 2 wt % A-C 395/ | | | | AB; FT | FT | FT | Hazy |
| | 10 wt % Epolene N15/ | | | | | | | |
| | 17 wt % Escorez 5690/ | | | | | | | |
| | 0.5 wt % Irganox 1010 | | | | | | | |
| 35B | 70.5 wt % Polymer Blend A/ | 1.7-2 | 1,112 | Flex | 2/ | 52/ | 55/ | Yellow- |
| | 10 wt % A-C 330/ | | | | AB | AB | AB; FT | Brown, |
| | 4 wt % A-C 645P/ | | | | | | | Hazy |
| | 15 wt % Escorez 5615/ | | | | | | | |
| | 0.5 wt % Irganox 1010 | | | | | | | |
| 36B | 70.5 wt % Polymer Blend A/ | 1.3-1.5 | 1,072 | Flex | 0/ | 0/ | 70/FT | Brown, |
| | 4 wt % A-C 395/ | | | | AB; AF | AB; AF | | Hazy |
| | 10 wt % Epolene N15/ | | | | | | | |
| | 0.5 wt % Irganox 1010 | | | | | | | |
| 37B | 65.5 wt % Polymer Blend A/ | 1 | 380 | Brittle | 0/ | 0/ | 0/ | Yellow- |
| | 15 wt % A-C 330/ | | | | AB | AB | AB | Brown, |
| | 4 wt % Polywax 3000/ | | | | | | | Clear |
| | 0.5 wt % Irganox 1010 | | | | | | | |
| 38B | 65.5 wt % Polymer Blend A/ | 0.7-1 | 470 | Flex | 0/ | 0/ | 0/ | Clear |
| | 4 wt % A-C 580/ | | | | AB | AB | AB; FT | |
| | 15 wt % Epolene N15/ | | | | | | | |
| | 15 wt % Escorez 5615/ | | | | | | | |
| | 0.5 wt % Irganox 1010 | | | | | | | |
| 39B | 65.5 wt % Polymer Blend A/ | 1-1.5 | 535 | Flex | 0/ | 0/ | 46/ | Clear |
| | 15 wt % A-C 330/ | | | | AF; AB | AF; AB | FT; AB | |
| | 4 wt % A-C 645P/ | | | | | | | |
| | 15 wt % Escorez 5615/ | | | | | | | |
| | 0.5 wt % Irganox 1010 | | | | | | | |
| 40B | 65.5 wt % Polymer Blend A/ | 0.7-1 | 440 | Flex | 0/ | 0/ | 0/ | Yellow- |
| | 4 wt % A-C 395/ | | | | AF | AF | AB; AF | Brown, |
| | 15 wt % Epolene N15/ | | | | | | | Clear |
| | 15 wt % Escorez 5615/ | | | | | | | |
| | 0.5 wt % Irganox 1010 | | | | | | | |
| Control | Advantra 9250 | 1.5 | | | 0/ | 13/ | 54/ | Clear |
| | | | | | AB; AF | AB | FT | |
| 41B | 70.5 wt % Polymer Blend A/ | — | 1,293 | — | — | — | — | — |
| | 2 wt % A-C 395/ | | | | | | | |
| | 10 wt % Epolene N15/ | | | | | | | |
| | 17 wt % Escorez 5615/ | | | | | | | |
| | 0.5 wt % Irganox 1010 | | | | | | | |
| 42B | 70.5 wt % Polymer Blend A/ | — | 1,255 | — | — | — | — | — |
| | 2 wt % A-C 395/ | | | | | | | |
| | 10 wt % Epolene N15/ | | | | | | | |
| | 17 wt % Escorez 5600/ | | | | | | | |
| | 0.5 wt % Irganox 1010 | | | | | | | |
| 43B | 70.5 wt % Polymer Blend A/ | — | 1,260 | — | — | — | — | — |
| | 2 wt % A-C 395/ | | | | | | | |
| | 10 wt % Epolene N15/ | | | | | | | |
| | 17 wt % Escorez 5690/ | | | | | | | |
| | 0.5 wt % Irganox 1010 | | | | | | | |
| 44B | 93 wt % Polymer Blend A/ | — | 1,220 | — | — | — | — | — |
| | 6.5 wt % Epoxidized Soybean | | | | | | | |
| | Oil/ | | | | | | | |
| | 0.5 wt % Irganox 1010 | | | | | | | |
| 45B | 92.5 wt % Polymer Blend A/ | — | 1,203 | — | — | — | — | — |
| | 7 wt % Epoxidized Soybean | | | | | | | |
| | Oil/ | | | | | | | |
| | 0.5 wt % Irganox 1010 | | | | | | | |
| 46B | 69.5 wt % Polymer Blend A/ | 3.5 | 945 | Flex | 0/ | 0/ | 0/ | White, |
| | 5 wt % Escorene UL7710/ | | | | AB | AB; AF | AB | Hazy |
| | 2 wt % A-C 395/ | | | | | | | |
| | 5 wt % Calumet Paraffin Wax/ | | | | | | | |
| | 16 wt % Escorez 5615/ | | | | | | | |
| | 2 wt % Epoxidized Soybean | | | | | | | |
| | Oil/ | | | | | | | |
| | 0.5 wt % Irganox 1010 | | | | | | | |
| 47B | 71.5 wt % Polymer Blend A/ | 2 | 1,075 | Flex | 0/ | 0/ | 60/ | Yellow- |
| | 5 wt % Escorene UL7710/ | | | | AB | AB; AF | FT | Brown, |
| | 2 wt % A-C 395/ | | | | | | | Hazy |
| | 5 wt % Paraflint H1/ | | | | | | | |
| | 8 wt % Escorez 2203LC/ | | | | | | | |
| | 8 wt % Escorez 5615/ | | | | | | | |
| | 0.5 wt % Irganox 1010 | | | | | | | |
| 48B | 64.5 wt % Polymer Blend A/ | 2-2.3 | 1,085 | Brittle | 0/ | 0/ | 0/ | Yellow, |
| | 10 wt % A-C 330/ | | | | AB | AF; AF | AB | Hazy |
| | 2 wt % A-C 645P/ | | | | | | | |
| | 5 wt % Paraflint H1/ | | | | | | | |
| | 16 wt % Escorez 5615/ | | | | | | | |
| | 2 wt % Epoxidized Soybean | | | | | | | |
| | Oil/ | | | | | | | |
| | 0.5 wt % Irganox 1010 | | | | | | | |
| 49B | 66.5 wt % Polymer Blend A/ | 2.7-3 | 945 | Flex | 0/ | 5/ | 65/ | Yellow- |
| | 10 wt % A-C 330/ | | | | AB | AB | FT | Brown, |
| | 2 wt % A-C 645P/ | | | | | | | Hazy |
| | 5 wt % Calumet Paraffin Wax/ | | | | | | | |
| | 8 wt % Escorez 2203LC/ | | | | | | | |
| | 8 wt % Escorez 5615/ | | | | | | | |
| | 0.5 wt % Irganox 1010 | | | | | | | |
| 50B | 64.5 wt % Polymer Blend A/ | 1.3-1.5 | 940 | Flex | 0/ | 0/ | 0/ | Yellow, |
| | 2 wt % A-C 395/ | | | | AB | AB; AF | AB; AF | Hazy |
| | 10 wt % Epolene N15/ | | | | | | | |
| | 5 wt % Calumet Paraffin Wax/ | | | | | | | |
| | 16 wt % Escorez 5615/ | | | | | | | |
| | 2 wt % Epoxidized Soybean | | | | | | | |
| | Oil/ | | | | | | | |
| | 0.5 wt % Irganox 1010 | | | | | | | |
| 51B | 66.5 wt % Polymer Blend A/ | 1.3-1.5 | 905 | Flex | 0/ | 0/ | 62/ | Yellow- |
| | 2 wt % A-C 395/ | | | | AB | AB; AF | FT | Brown, |
| | 10 wt % Epolene N15/ | | | | | | | Hazy |
| | 5 wt % Paraflint H1/ | | | | | | | |
| | 8 wt % Escorez 2203LC/ | | | | | | | |
| | 8 wt % Escorez 5615/ | | | | | | | |
| | 0.5 wt % Irganox 1010 | | | | | | | |
| 52B | 74.5 wt % Polymer Blend A/ | 3 | 890 | Flex | 0/ | 0/ | 0/ | Clear |
| | 2 wt % A-C 395/ | | | | AB | AB; AF | AB | |
| | 5 wt % Calumet Paraffin Wax/ | | | | | | | |
| | 8 wt % Escorez 5600/ | | | | | | | |
| | 8 wt % Escorez 5690/ | | | | | | | |
| | 2 wt % Epoxidized Soybean Oil/ | | | | | | | |
| | 0.5 wt % Irganox 1010 | | | | | | | |
| 53B | 76.5 wt % Polymer Blend A/ | 2-2.3 | 960 | Flex | 0/ | 58/ | 95/ | Clear |
| | 2 wt % A-C 395/ | | | | AB | AB; FT | FT | |
| | 5 wt % Paraflint H1/ | | | | | | | |
| | 8 wt % Escorez 5600/ | | | | | | | |
| | 8 wt % Escorez 5690/ | | | | | | | |
| | 0.5 wt % Irganox 1010 | | | | | | | |
| 54B | 74.5 wt % Polymer Blend A/ | 2-2.3 | 1,035 | Brittle | 0/ | 0/ | 0/ | Yellow, |
| | 2 wt % A-C 395/ | | | | AB | AB; AF | AB | Clear |
| | 5 wt % Paraflint H1/ | | | | | | | |
| | 8 wt % Escorez 2203LC/ | | | | | | | |
| | 8 wt % Escorez 5637/ | | | | | | | |
| | 2 wt % Epoxidized Soybean Oil/ | | | | | | | |
| | 0.5 wt % Irganox 1010 | | | | | | | |
| 55B | 71.5 wt % Polymer Blend A/ | 2.7-3 | 930 | Flex | 35/ | 88/ | 99/ | Yellow, |
| | 5 wt % Escorene UL7710/ | | | | AB | FT | FT | Clear |
| | 2 wt % A-C 395/ | | | | | | | |
| | 5 wt % Paraflint H1/ | | | | | | | |
| | 8 wt % Escorez 2203LC/ | | | | | | | |
| | 8 wt % Escorez 5615/ | | | | | | | |
| | 0.5 wt % Irganox 1010 | | | | | | | |
| Control | Advantra 9250 | 1.5 | — | — | 33/ | 47/ | 85/ | Clear |
| | | | | | FT; AB | FT | FT | |
| 56B | 80.5 wt % Polymer Blend A/ | — | 1,270 | Flex | — | — | — | Yellow, |
| | 2 wt % A-C 395/ | | | | | | | Hazy |
| | 1 wt % Calumet Paraffin Wax/ | | | | | | | |
| | 8 wt % Escorez 5600/ | | | | | | | |
| | 8 wt % Escorez 5690/ | | | | | | | |
| | 0.5 wt % Irganox 1010 | | | | | | | |
| 57B | 79.5 wt % Polymer Blend A/ | — | 1,225 | Flex | — | — | — | Yellow, |
| | 2 wt % A-C 395/ | | | | | | | Hazy |
| | 2 wt % Calumet Paraffin Wax/ | | | | | | | |
| | 8 wt % Escorez 5600/ | | | | | | | |
| | 8 wt % Escorez 5690/ | | | | | | | |
| | 0.5 wt % Irganox 1010 | | | | | | | |
| 58B | 78.5 wt % Polymer Blend A/ | — | 1,160 | Flex | — | — | — | Yellow, |
| | 2 wt % A-C 395/ | | | | | | | Hazy |
| | 3 wt % Calumet Paraffin Wax/ | | | | | | | |
| | 8 wt % Escorez 5600/ | | | | | | | |
| | 8 wt % Escorez 5690/ | | | | | | | |
| | 0.5 wt % Irganox 1010 | | | | | | | |
| 59B | 78.5 wt % Polymer Blend A/ | — | 1,220 | Flex | — | — | — | |
| | 2 wt % A-C 395/ | | | | | | | |
| | 1 wt % Calumet Paraffin Wax/ | | | | | | | |
| | 8 wt % Escorez 5600/ | | | | | | | |
| | 8 wt % Escorez 5690/ | | | | | | | |
| | 2 wt % Spectrasyn 65/ | | | | | | | |
| | 0.5 wt % Irganox 1010 | | | | | | | |
| 60B | 76.5 wt % Polymer Blend A/ | — | 1,130 | Flex | — | — | — | |
| | 2 wt % A-C 395/ | | | | | | | |
| | 1 wt % Calumet Paraffin Wax/ | | | | | | | |
| | 8 wt % Escorez 5600/ | | | | | | | |
| | 8 wt % Escorez 5690/ | | | | | | | |
| | 4 wt % Spectrasyn 65/ | | | | | | | |
| | 0.5 wt % Irganox 1010 | | | | | | | |
| 61B | 80.5 wt % Polymer Blend A/ | — | 1,290 | Flex | — | — | — | |
| | 2 wt % A-C 395/ | | | | | | | |
| | 1 wt % Calumet Paraffin Wax/ | | | | | | | |
| | 8 wt % Escorez 2203LC/ | | | | | | | |
| | 8 wt % Escorez 5400/ | | | | | | | |
| | 0.5 wt % Irganox 1010 | | | | | | | |
| 62B | 79.5 wt % Polymer Blend A/ | — | 1,230 | Flex | — | — | — | |
| | 2 wt % A-C 395/ | | | | | | | |
| | 2 wt % Calumet Paraffin Wax/ | | | | | | | |
| | 8 wt % Escorez 2203LC/ | | | | | | | |
| | 8 wt % Escorez 5400/ | | | | | | | |
| | 0.5 wt % Irganox 1010 | | | | | | | |
| 63B | 78.5 wt % Polymer Blend A/ | — | 1,185 | Flex | — | — | — | |
| | 2 wt % A-C 395/ | | | | | | | |
| | 3 wt % Calumet Paraffin Wax/ | | | | | | | |
| | 8 wt % Escorez 2203LC/ | | | | | | | |
| | 8 wt % Escorez 5400/ | | | | | | | |
| | 0.5 wt % Irganox 1010 | | | | | | | |
| 64B | 78.5 wt % Polymer Blend A/ | — | 1,195 | Flex | — | — | — | |
| | 2 wt % A-C 395/ | | | | | | | |
| | 1 wt % Calumet Paraffin Wax/ | | | | | | | |
| | 8 wt % Escorez 2203LC/ | | | | | | | |
| | 8 wt % Escorez 5400/ | | | | | | | |
| | 2 wt % Spectrasyn 65 | | | | | | | |
| | 0.5 wt % Irganox 1010 | | | | | | | |
| 65B | 76.5 wt % Polymer Blend A/ | — | 1,135 | Flex | — | — | — | |
| | 2 wt % A-C 395/ | | | | | | | |
| | 1 wt % Calumet Paraffin Wax/ | | | | | | | |
| | 8 wt % Escorez 2203LC/ | | | | | | | |
| | 8 wt % Escorez 5400/ | | | | | | | |
| | 4 wt % Spectrasyn 65/ | | | | | | | |
| | 0.5 wt % Irganox 1010 | | | | | | | |

TABLE 3

| | | | | % Fiber |
|---|---|---|---|---|
| | | | Formulation | Tear |
| | | Set | Viscosity | −18° C./ |
| | Adhesive Formulation | Time | (cP) | 0° C./ |
| | (wt % of the Adhesive) | (sec) | at 175° C. | 23° C. |
| 1C | 70.5 wt % Polymer Blend A/ | 1 | 738 | 100/ |
| | 2 wt % A-C 596/ | | | 100/ |
| | 2 wt % A-C 325/ | | | 100 |
| | 10 wt % Paraffin Wax | | | |
| | 15 wt % Escorez 5600/ | | | |
| | 0.5 wt % Irganox 1010 | | | |
| 2C | 70.5 wt % Polymer Blend A/ | 3 | 671 | 100/ |
| | 2 wt % A-C 596/ | | | 100/ |
| | 2 wt % A-C 325/ | | | 100 |
| | 10 wt % Paraffin wax/ | | | |
| | 12 wt % Escorez 5600/ | | | |
| | 3 wt % Primol 352/ | | | |
| | 0.5 wt % Irganox 1010 | | | |
| 3C | 70.5 wt % Polymer Blend A/ | 3 | 684 | 100/ |
| | 2 wt % A-C 596/ | | | 100/ |
| | 2 wt % A-C 325/ | | | 100 |
| | 10 wt % Paraffin wax/ | | | |
| | 12 wt % Escorez 5600/ | | | |
| | 3 wt % Spectrasyn 40/ | | | |
| | 0.5 wt % Irganox 1010 | | | |
| 4C | 70.5 wt % Polymer Blend A/ | 1 | 796 | 100/ |
| | 2 wt % A-C 596/ | | | 100/ |
| | 2 wt % A-C 325/ | | | 100 |
| | 10 wt % Shell HMP wax/ | | | |
| | 15 wt % Escorez 5600/ | | | |
| | 0.5 wt % Irganox 1010 | | | |
| 5C | 70.5 wt % Polymer Blend A/ | 1.5 | 624 | 100/ |
| | 1 wt % A-C 325/ | | | 100/ |
| | 10 wt % Paraffin wax/ | | | 100 |
| | 15 wt % Escorez 5600/ | | | |
| | 3 wt % Primol 352/ | | | |
| | 0.5 wt % Irganox 1010 | | | |
| 6C | 70.5 wt % Polymer Blend A/ | 1.5 | 794 | 100/ |
| | 1 wt % A-C 325/ | | | 100/ |
| | 5 wt % Paraffin wax/ | | | 100 |
| | 20 wt % Escorez 5600/ | | | |
| | 3 wt % Primol 352/ | | | |
| | 0.5 wt % Irganox 1010 | | | |
| 7C | 70.5 wt % Polymer Blend A/ | 3 | 659 | 100/ |
| | 2 wt % A-C 325/ | | | 100/ |
| | 10 wt % Paraffin wax/ | | | 100 |
| | 14 wt % Escorez 5600/ | | | |
| | 3 wt % Primol 352/ | | | |
| | 0.5 wt % Irganox 1010 | | | |
| 8C | 90 wt % Polymer Blend A/ | 1 | 1,458 | 100/ |
| | 3.5 wt % A-C 596/ | | | 100/ |
| | 2.5 wt % A-C 325/ | | | 100 |
| | 3.5 wt % Escorez 5600/ | | | |
| | 0.5 wt % Irganox 1010 | | | |

TABLE 4

| | | | Formulation |
|---|---|---|---|
| | | Set | Viscosity |
| | Adhesive Formulation | Time | (cP) |
| | (wt % of the Adhesive) | (sec) | at 175° C. |
| 1D | 90 wt % Polymer Blend A/ | 1.5 | 1,523 |
| | 3.5 wt % A-C 596/ | | |
| | 2.5 wt % A-C 325/ | | |
| | 3.5 wt % Escorez 5400/ | | |
| | 0.5 wt % Irganox 1010 | | |
| 2D | 90 wt % Polymer Blend A/ | 1 | 1,540 |
| | 3.5 wt % A-C 596/ | | |
| | 2.5 wt % A-C 316/ | | |
| | 3.5 wt % Escorez 5400/ | | |
| | 0.5 wt % Irganox 1010 | | |
| 3D | 90 wt % Polymer Blend A/ | 2 | 1,568 |
| | 3.5 wt % A-C 596/ | | |
| | 2.5 wt % A-C 673/ | | |
| | 3.5 wt % Escorez 5400/ | | |
| | 0.5 wt % Irganox 1010 | | |
| 4D | 90 wt % Polymer Blend A/ | 1.5 | 1,460 |
| | 3.5 wt % A-C 596/ | | |
| | 2.5 wt % A-C 629/ | | |
| | 3.5 wt % Escorez 5400/ | | |
| | 0.5 wt % Irganox 1010 | | |

TABLE 5

| | | | Formulation |
|---|---|---|---|
| | | Set | Viscosity |
| | Adhesive Formulation | Time | (cP) |
| | (wt % of the Adhesive) | (sec) | at 177° C. |
| 1E | 70 wt % Polymer Blend A/ | 15 | 1,600 |
| | 17.5 wt % Escorez 5600/ | | |
| | 10 wt % A-C 596/ | | |
| | 2 wt % Epolene N15/ | | |
| | 0.5 wt % Irganox 1010 | | |
| 2E | 70 wt % Polymer Blend A/ | 1.5 | 1,945 |
| | 17.5 wt % Escorez 5600/ | | |
| | 10 wt % Epolene N15/ | | |
| | 2 wt % A-C 325/ | | |
| | 0.5 wt % Irganox 1010 | | |
| 3E | 70 wt % Polymer Blend A/ | — | — |
| | 15.5 wt % Escorez 5600/ | | |
| | 10 wt % Epolene N15/ | | |
| | 2 wt % A-C 325/ | | |
| | 2 wt % Primol 352/ | | |
| | 0.5 wt % Irganox 1010 | | |
| 4E | 70 wt % Polymer Blend A/ | — | — |
| | 15.5 wt % Escorez 5600/ | | |
| | 9 wt % Epolene N15/ | | |
| | 2 wt % A-C 325/ | | |
| | 3 wt % Primol 352/ | | |
| | 0.5 wt % Irganox 1010 | | |
| 5E | 70 wt % Polymer Blend A/ | 2.3-2.5 | 1,018 |
| | 15.5 wt % Escorez 5600/ | | |
| | 10 wt % Paraffin wax/ | | |
| | 2 wt % Epolene N15/ | | |
| | 2 wt % A-C 325/ | | |
| | 0.5 wt % Irganox 1010 | | |
| 6E | 70 wt % Polymer Blend A/ | — | — |
| | 15.5 wt % Escorez 5600/ | | |
| | 5 wt % Paraffin wax/ | | |
| | 7 wt % Epolene N15/ | | |
| | 2 wt % A-C 325/ | | |
| | 0.5 wt % Irganox 1010 | | |
| 7E | 75 wt % Polymer Blend A/ | — | — |
| | 15.5 wt % Escorez 5600/ | | |
| | 2 wt % Paraffin wax/ | | |
| | 5 wt % Epolene N15/ | | |
| | 2 wt % A-C 325/ | | |
| | 0.5 wt % Irganox 1010 | | |
| 8E | 70 wt % Polymer Blend A/ | — | — |
| | 15.5 wt % Escorez 5600/ | | |
| | 3 wt % Paraffin wax/ | | |
| | 9 wt % Epolene N15/ | | |
| | 2 wt % A-C 325/ | | |
| | 0.5 wt % Irganox 1010 | | |
| 9E | 70 wt % Polymer Blend A/ | 3 | 993 |
| | 15.5 wt % Escorez 5600/ | | |
| | 10 wt % Paraffin wax/ | | |
| | 2 wt % A-C 596/ | | |
| | 2 wt % A-C 325/ | | |
| | 0.5 wt % Irganox 1010 | | |
| 10E | 70 wt % Polymer Blend A/ | 3.5-3.7 | 988 |
| | 16.5 wt % Escorez 5600/ | | |
| | 10 wt % Paraffin wax/ | | |
| | 1 wt % Sasolwax H1/ | | |
| | 2 wt % A-C 325/ | | |
| | 0.5 wt % Irganox 1010 | | |
| 11E | 70 wt % Polymer Blend A/ | 3 | 960 |
| | 15.5 wt % Escorez 5600/ | | |
| | 10 wt % Paraffin wax/ | | |
| | 2 wt % A-C 325/ | | |
| | 2 wt % Primol 352/ | | |
| | 0.5 wt % Irganox 1010 | | |
| 12E | 75 wt % Polymer Blend A/ | — | — |
| | 15.5 wt % Escorez 5600. | | |
| | 5 wt % Paraffin wax/ | | |
| | 2 wt % A-C 325/ | | |
| | 2 wt % Primol 352/ | | |
| | 0.5 wt % Irganox 1010 | | |
| 13E | 72 wt % Polymer Blend A/ | — | — |
| | 15.5 wt % Escorez 5600/ | | |
| | 5 wt % Paraffin wax/ | | |
| | 2 wt % A-C 325/ | | |
| | 2 wt % Primol 352/ | | |
| | 0.5 wt % Irganox 1010 | | |
| 14E | 76 wt % Polymer Blend A/ | — | — |
| | 15.5 wt % Escorez 5600/ | | |
| | 5 wt % Paraffin wax/ | | |
| | 2 wt % A-C 325/ | | |
| | 1 wt % Primol 352/ | | |
| | 0.5 wt % Irganox 1010 | | |
| 15E | 74 wt % Polymer Blend A/ | — | — |
| | 15.5 wt % Escorez 5600/ | | |
| | 5 wt % Paraffin wax/ | | |
| | 2 wt % A-C 325/ | | |
| | 3 wt % Primol 352/ | | |
| | 0.5 wt % Irganox 1010 | | |
| 16E | 72 wt % Polymer Blend A/ | — | — |
| | 15.5 wt % Escorez 5600/ | | |
| | 5 wt % Paraffin wax/ | | |
| | 2 wt % A-C 325/ | | |
| | 5 wt % Primol 352/ | | |
| | 0.5 wt % Irganox 1010 | | |
| 17E | 70 wt % Polymer Blend A/ | 2.3-2.5 | 1,018 |
| | 15.5 wt % Escorez 5600/ | | |
| | 10 wt % Paraffin wax/ | | |
| | 2 wt % Epolene N15/ | | |
| | 2 wt % A-C 325/ | | |
| | 0.5 wt % Irganox 1010 | | |
| 18E | 70 wt % Polymer Blend A/ | 3-3.3 | 1,075 |
| | 15.5 wt % Escorez 5600/ | | |
| | 10 wt % Paraffin wax/ | | |
| | 2 wt % A-C 325/ | | |
| | 2 wt % Epolene C15/ | | |
| | 0.5 wt % Irganox 1010 | | |
| 19E | 62 wt % Polymer Blend A/ | 3.3-3.5 | 1,163 |
| | 15.5 wt % Escorez 5600/ | | |
| | 10 wt % Paraffin wax/ | | |
| | 2 wt % A-C 325/ | | |
| | 10 wt % Epolene C15/ | | |
| | 0.5 wt % Irganox 1010 | | |
| 20E | 70 wt % Polymer Blend A/ | 3.3-3.5 | 973 |
| | 15.5 wt % Escorez 5600/ | | |
| | 10 wt % Paraffin wax/ | | |
| | 2 wt % A-C 325/ | | |
| | 2 wt % Spectrasyn 40/ | | |
| | 0.5 wt % Irganox 1010 | | |
| 21E | 70 wt % Polymer Blend A/ | 2.7-3 | 985 |
| | 15.5 wt % Escorez 5600/ | | |
| | 10 wt % Paraffin wax/ | | |
| | 2 wt % A-C 325/ | | |
| | 2 wt % Licocene 5301/ | | |
| | 0.5 wt % Irganox 1010 | | |

We claim:

1. An adhesive composition comprising:
(a) a polymer blend comprising
a first propylene-based polymer, wherein the first propylene-based polymer is a homopolymer of propylene or a copolymer of propylene and ethylene or a C₄ to C₁₀ alpha-olefin; a second propylene-based polymer, wherein the second propylene-based polymer is a homopolymer of propylene or a copolymer of propylene and ethylene or a C₄ to C₁₀ alpha-olefin; wherein the second propylene-based polymer is different than the first propylene-based polymer;
wherein the polymer blend is present in the amount of about 65 wt % or more based on the adhesive composition;
wherein the polymer blend has a melt viscosity, measured at 190° C. of about 900 to about 19,000 cP; and
(b) a polar polyethylene component selected from at least one of an oxidized high density polyethylene wax, a silane-modified polyethylene, ethylene vinyl acetate, ethylene acrylate, organic acid-modified polyethylene, and combinations thereof.

2. The adhesive composition of claim 1, wherein the polar polyethylene component is selected from an oxidized high density polyethylene wax, an organic acid-modified polyethylene, and combinations thereof.

3. The adhesive composition of claim 1, wherein the ethylene acrylate is selected from an ethylene n-butyl acrylate, ethylene methyl acrylate, ethylene acrylic acid, and combinations thereof.

4. The adhesive composition of claim 1, wherein the adhesive composition has a melt viscosity, measured at 177° C. of about 200 to about 5,000 cP.

5. The adhesive composition of claim 1, further comprising a functionalized polyolefin, wherein the functionalized polyolefin is selected from the group consisting of a maleic anhydride-modified polypropylene and a maleic anhydride-modified polypropylene wax, wherein the polyolefin is present in the amount of less than or equal to about 5 wt % of the adhesive composition.

6. The adhesive composition of claim 1, further comprising an antioxidant present in the amount of about 0.01 to about 1 wt % of the adhesive composition.

7. The adhesive composition of claim 1, further comprising a tackifier.

8. The adhesive composition of claim 1, further comprising an oil, wherein the oil is selected from at least one of a white oil, naphthenic oil, poly-alpha-olefin, mineral oil, and combinations thereof.

9. The adhesive composition of claim 1, further comprising a wax, wherein the wax is selected from at least one of a crystalline polypropylene wax, paraffin wax, microcrystalline wax, and combinations thereof.

10. The adhesive composition of claim 1, wherein the first propylene-based polymer comprises a copolymer of propylene and ethylene, and the second propylene-based polymer comprises a copolymer of propylene and ethylene.

11. An article comprising the adhesive composition of claim 1, wherein the adhesive composition adheres one or more substrates, and wherein at least one of the one or more substrates comprises paper, cardboard, plastic, nonwoven, metal, wood, other natural fiber based material, or combinations thereof.

12. A process to prepare an adhesive composition, comprising combining:
(a) a polymer blend, comprising
a first propylene-based polymer, wherein the first propylene-based polymer is a homopolymer of propylene or a copolymer of propylene and ethylene or a C₄ to C₁₀ alpha-olefin; a second propylene-based polymer, wherein the second propylene-based polymer is a homopolymer of propylene or a copolymer of propylene and ethylene or a C₄ to C₁₀ alpha-olefin; wherein the second propylene-based polymer is different than the first propylene-based polymer;
wherein the polymer blend is present in the amount of about 65 wt % or more based on the adhesive composition;
wherein the polymer blend has a melt viscosity, measured at 190° C. of about 900 to about 19,000 cP; and
(b) a polar polyethylene component selected from at least one of an oxidized high density polyethylene wax, a silane-modified polyethylene, ethylene vinyl acetate, ethylene acrylate, organic acid-modified polyethylene, and combinations thereof.

13. The process of claim 12, wherein the polar polyethylene component is selected from an oxidized high density polyethylene wax, an organic acid-modified polyethylene, and combinations thereof.

14. The process of claim 12, wherein the adhesive composition further comprises a functionalized polyolefin, wherein the functionalized polyolefin is selected from the group consisting of a maleic anhydride-modified polypropylene and a maleic anhydride-modified polypropylene wax, wherein the polyolefin is present in the amount of less than or equal to about 5 wt % of the adhesive composition.
